(19) United States
(12) Patent Application Publication
(10) Pub. No.: US 2025/0175961 A1
(43) Pub. Date: May 29, 2025

(54) DETERMINING METHOD AND TERMINAL

(71) Applicant: VIVO MOBILE COMMUNICATION CO., LTD., Dongguan (CN)

(72) Inventors: Lihui WANG, Dongguan (CN); Xueming PAN, Dongguan (CN)

(73) Assignee: VIVO MOBILE COMMUNICATION CO., LTD., Dongguan (CN)

(21) Appl. No.: 19/037,041

(22) Filed: Jan. 24, 2025

Related U.S. Application Data
(63) Continuation of application No. PCT/CN2023/108158, filed on Jul. 19, 2023.

(30) Foreign Application Priority Data
Jul. 25, 2022 (CN) 202210879046.X

(51) Int. Cl. H04W 72/0453; H04L 5/14

(52) U.S. Cl. CPC H04W 72/0453; H04L 5/14

(57) ABSTRACT

This application discloses a determining method and a terminal. The determining method includes: a terminal obtains target information of to-be-transmitted target data, and determines a target transmission resource of the target data based on the target information. The target information is information related to transmission of the target data. The target transmission resource includes a target start Resource Block (RB).

### CROSS-REFERENCE TO RELATED APPLICATIONS

This application is a continuation of International Application No. PCT/CN 2023/108158, filed on Jul. 19, 2023, which claims priority to Chinese Patent Application No. 202210879046.X, filed on Jul. 25, 2022. The entire contents of each of the above-referenced applications are expressly incorporated herein by reference.

### TECHNICAL FIELD

This application pertains to the field of communication technologies, and specifically, to a determining method and a terminal.

### BACKGROUND

Currently, in a conventional Time Division Duplexing (TDD) standard and a conventional Frequency Division Duplexing (FDD) standard, on symmetrical spectrums of a same BandWidth Part (BWP), frequency domain locations of uplink resources and downlink resources at different moments/in time units of the symmetrical spectrums are of a same size.

However, a flexible/full duplex standard supports the following case: On asymmetric spectrums of the BWP, a BWP at a same moment/in a same time unit may include both an uplink resource and a downlink resource, but at different moments/in different time units, a downlink resource and an uplink resource on a same BWP may be the same or different in terms of frequency domain locations (that is, a start Resource Block (RB) and an end physical resource block) and sizes, that is, the number of occupied physical resource blocks. In this way, in a flexible/full duplex standard, UE may be unable to determine a specific start RB occupied for data/signal transmission at each moment/in each time unit of the UE. Therefore, a method is urgently needed to enable a terminal to determine a start RB occupied by the terminal to transmit data/signal in each time unit.

### SUMMARY

Embodiments of this application provide a determining method and a terminal, so that the terminal can determine a start RB occupied by the terminal to transmit data/signals in each time unit.

According to a first aspect, a determining method is provided and is applied to a terminal, and the method includes: A terminal obtains target information of to-be-transmitted target data, where the target information is information related to transmission of the target data; and determines a target transmission resource of the target data based on the target information, where the target transmission resource includes a target start resource block RB.

According to a second aspect, a determining apparatus is provided. The apparatus includes an obtaining module and a determining module. The obtaining module is configured to obtain target information of to-be-transmitted target data, where the target information is information related to transmission of the target data. The determining module is configured to determine a target transmission resource of the target data based on the target information, where the target transmission resource includes a target start resource block RB.

According to a third aspect, a terminal is provided. The terminal includes a processor and a memory, the memory stores a program or an instruction that can be run on the processor, and when the program or the instruction is executed by the processor, the steps of the method according to the first aspect are implemented.

According to a fourth aspect, a terminal is provided, including a processor and a communication interface. The processor is configured to: obtain target information of to-be-transmitted target data, where the target information is information related to transmission of the target data; and determine a target transmission resource of the target data based on the target information, where the target transmission resource includes a target start resource block RB.

According to a fifth aspect, a readable storage medium is provided. The readable storage medium stores a program or an instruction, and when the program or the instruction is executed by a processor, the steps of the method according to the first aspect are implemented, or the steps of the method according to the third aspect are implemented.

According to a sixth aspect, a chip is provided. The chip includes a processor and a communication interface, the communication interface is coupled to the processor, and the processor is configured to run a program or an instruction to implement the steps of the determining method according to the first aspect.

According to a seventh aspect, a computer program/program product is provided. The computer program/program product is stored in a storage medium, and the computer program/program product is executed by at least one processor to implement the steps of the determining method according to the first aspect.

In the embodiments of this application, a terminal obtains target information of to-be-transmitted target data, where the target information is information related to transmission of the target data; and determines a target transmission resource of the target data based on the target information, where the target transmission resource includes a target start resource block RB. The terminal can obtain the target information related to the to-be-transmitted target data, so that the terminal can determine, based on the target information, the target transmission resource used to transmit the target data, that is, can determine the target start resource block RB.

### BRIEF DESCRIPTION OF DRAWINGS

FIG. 1 is a schematic architecture diagram of a wireless communication system according to an embodiment of this application;

FIG. 2 is a first schematic diagram of a determining method according to an embodiment of this application;

FIG. 3 is a second schematic diagram of a determining method according to an embodiment of this application;

FIG. 4 is a third schematic diagram of a determining method according to an embodiment of this application;

FIG. 5 is a fourth schematic diagram of a determining method according to an embodiment of this application;

FIG. 6 is a fifth schematic diagram of a determining method according to an embodiment of this application;

FIG. 7 is a sixth schematic diagram of a determining method according to an embodiment of this application;

FIG. 8 is a seventh schematic diagram of a determining method according to an embodiment of this application;

FIG. 9 is an eighth schematic diagram of a determining method according to an embodiment of this application;

FIG. 10 is a ninth schematic diagram of a determining method according to an embodiment of this application;

FIG. 11 is a tenth schematic diagram of a determining method according to an embodiment of this application;

FIG. 12 is an eleventh schematic diagram of a determining method according to an embodiment of this application;

FIG. 13 is a schematic diagram of a determining apparatus according to an embodiment of this application;

FIG. 14 is a schematic diagram of a hardware structure of a communication device according to an embodiment of this application; and

FIG. 15 is a schematic diagram of a hardware structure of a terminal according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} Generation (6G) communication system.

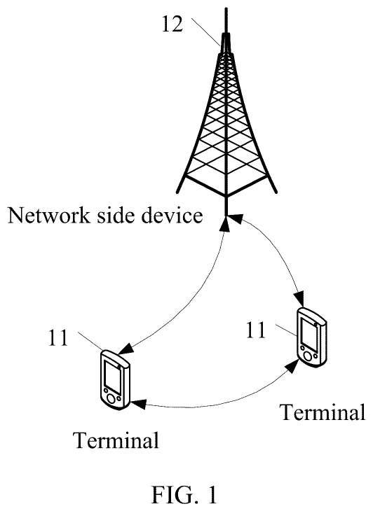

FIG. 1 is a block diagram of a wireless communication system to which embodiments of this application may be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home device (a home device with a wireless communication function, such as a refrigerator, a television, a washing machine, or a furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a WLAN access point, a WiFi node, and the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another proper term in the art, provided that the same technical effect is achieved. The base station is not limited to a specific technical vocabulary. It should be noted that in the embodiments of this application, a base station in an NR system is merely used as an example for description, but a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), Unified Data Repository (UDR), a Home Subscriber Server (HSS), Centralized network configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, only a core network device in the NR system is used as an example for description, and a specific type of the core network device is not limited.

With reference to the accompanying drawings, a determining method provided in the embodiments of this application is described in detail below by using specific embodiments and application scenarios thereof.

Some concepts and/or terms in a determining method and apparatus, a terminal, and a storage medium provided in the embodiments of this application are explained and described below.

Currently, spectrum standards deployed on a network are fixed, and mainly include the following two types:
Time Division Duplexing (TDD)

A same radio frequency is shared by transmission and reception. Different slots are used on an uplink and a downlink for communication.
Frequency Division Duplexing (FDD)

Different radio frequencies are used by transmission and reception for communication.

The foregoing two standards each have advantages and disadvantages. Because an uplink and a downlink of a TDD system are distinguished by time, it is unnecessary to require frequency bands with symmetric bandwidth. Therefore, fragmentary frequency bands may be used for TDD, which is suitable for a service that are obviously asymmetric on an uplink and a downlink. However, it is inconducive to delay-sensitive services, and because TDD transmission time is only approximately half that of FDD, coverage or throughput is limited. When the FDD system supports asymmetric services, spectrum utilization is significantly reduced. Therefore, future mobile communication requires more flexible use of spectrums. A flexible/full duplex operation on a network side and a half-duplex operation on a user/terminal side are considered as relatively potential technologies, which can improve spectrum utilization, improve uplink coverage, and reduce delay of the delay-sensitive service.

Features of the flexible/full duplex operation on the network side and the half-duplex operation on the user/terminal side in Rel-18

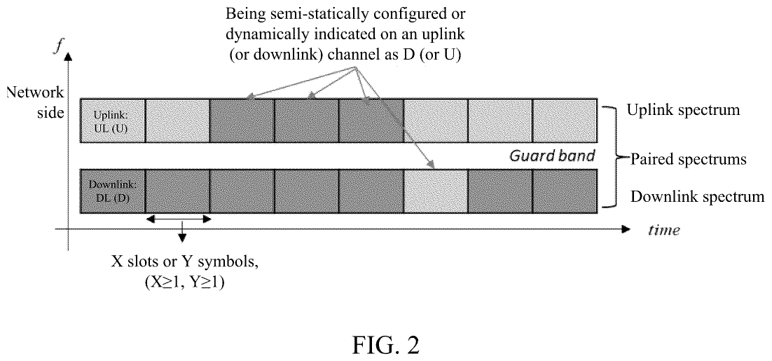

FIG. 2 is a schematic diagram of symmetric spectrums of FDD. As shown in FIG. 2, for the symmetric spectrums of FDD, an uplink or downlink spectrum of FDD may be semi-statically configured or dynamically indicated as downlink or uplink transmission in some slots/symbols.

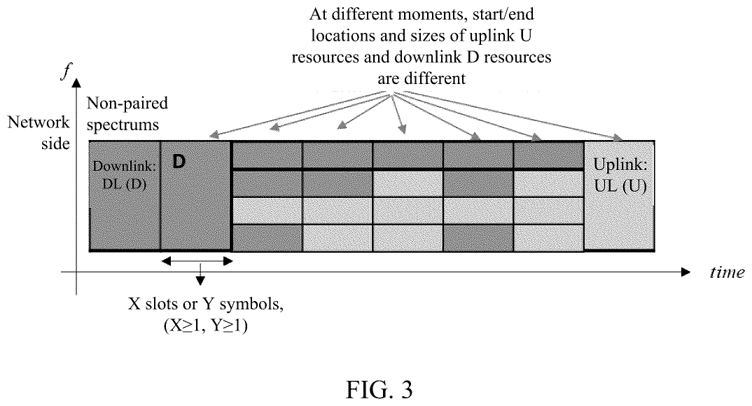

FIG. 3 is a schematic diagram of asymmetric spectrums of TDD. As shown in FIG. 3, for the asymmetric spectrums of TDD, different frequency domain resources in some slots/symbols of TDD may be semi-statically configured or dynamically indicated to have both uplink transmission and downlink reception.

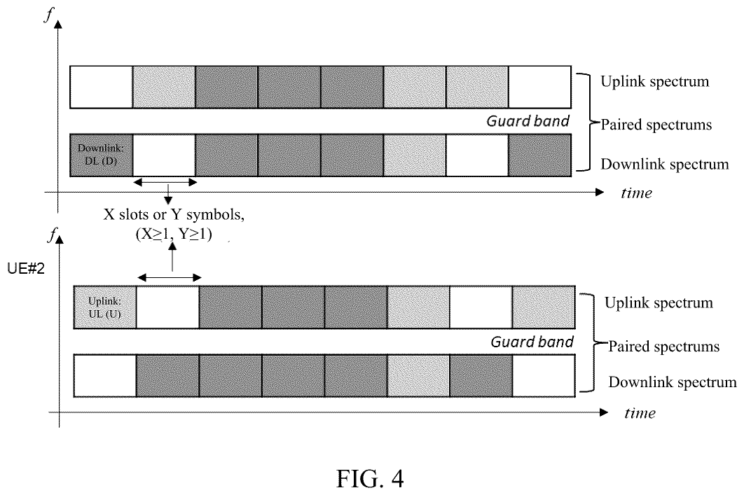

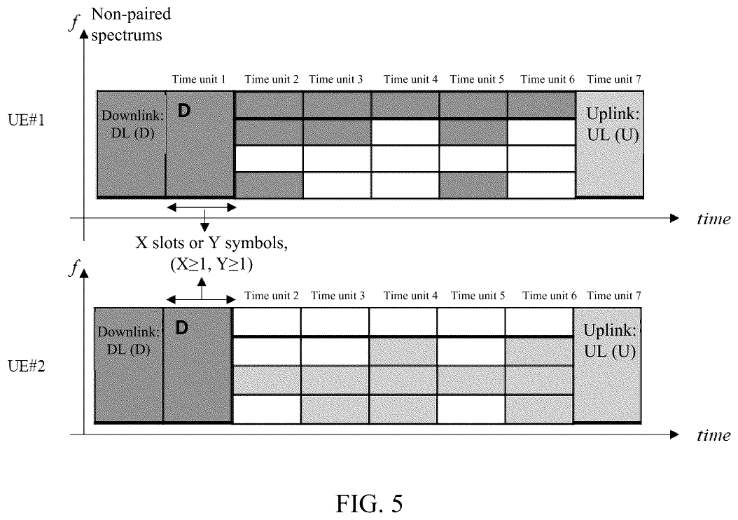

FIG. 4 and FIG. 5 are schematic diagrams of a spectrum of a half-duplex terminal. As shown in FIG. 4 and FIG. 5, for the half-duplex terminal, only uplink transmission or downlink reception can be performed at a same moment, that is, a terminal cannot receive and send a signal at a same moment, which are respectively corresponding to FIG. 2 and FIG. 3 on a network side. As shown in FIG. 5, for UE #1, downlink resources in time units 1, 2, 3, 4, and 7 are different in terms of frequency domain locations and sizes, and for UE #2, uplink resources in time units 1, 2, 3, 4, and 7 are different in terms of frequency domain locations and sizes. In conventional TDD and FDD standards, on a same BandWidth Part (BWP), downlink resources and uplink resources at different moments/in different time units are the same in terms of frequency domain locations and sizes.

Frequency domain resource allocation for a data channel

A New Radio (NR) network is deployed in TDD and FDD standards, and there are three types of frequency domain resource allocation: Type0, Type1, and Dynamic Switch.

Type0 is used to indicate that a bitmap allocation manner supports contiguous resource allocation and non-contiguous resource allocation.

Type1 is used to indicate that an RIV allocation manner supports only contiguous resource allocation.

Dynamic Switch is used to indicate whether to use Type0 or Type1 is determined by using a Digital Copyright Identifier (DCI) field.

Type0

Multiple consecutive RBs are bundled into a RBG, and are allocated to a Physical Downlink Shared Channel (PDSCH)/Physical Uplink Shared Channel (PUSCH) based on a multiple of the RBG. The number of RBs in RBs depends on a size and a configuration of a BWP, as shown in Table 5.1.2.2.1-1 (that is, Table 1) in TS38.214. A configuration type, that is, Configuration 1 or Configuration 2, is determined by a RBG-size field in PDSCH-Config in an RRC message. A bitmap in DCI indicates a RBG number that carries PDSCH or PUSCH data. Due to indication by the bitmap, RBG indexes are in a one-to-one correspondence with bit indexes in the bitmap. When a value of a bit is 1, it indicates that a corresponding RBG is allocated for transmission of this data. When a value of a bit is 0, it indicates that a corresponding RBG is not allocated for transmission of this data. Therefore, RBGs allocated for data transmission may be contiguous, or may be non-contiguous. A start RB for the data transmission is denoted as RB_start, which is a first RB in a smallest RBG index corresponding to a bit value 1 in the bitmap.

TABLE 1
Table 5.1.2.2.1-1: Nominal RBG size P

| Bandwidth Part Size | Configuration 1 | Configuration 1 |
|---|---|---|
| 1-36 | 2 | 4 |
| 37-72 | 4 | 8 |
| 93-144 | 8 | 16 |
| 145-275 | 16 | 16 |

Type1

Resources of Type1 are allocated to one or more consecutive RBs. A resource allocation area is defined by two parameters: a start RB for data transmission, that is, RB_Start, and a size of a BWP, that is, the number of consecutive RBs on the BWP. When resource allocation is specified in the DCI, RB_Start and the number of consecutive RBs in the BWP are combined into a specific single value, which is referred to as an Resource Indicator Value (RIV). The RIV is calculated according to a first formula, and in TS 38.214, a downlink is used as an example (a same method is used for an uplink).

The first formula is:

A downlink type 1 resource allocation feld consists of a resource indication value (RIV) corresponding to a starting virtual resource block (RBₛₜₐᵣₜ) and a length in terms of contiguously allocated resource blocks L_{RBs}. The resource indicatiom value is defined by

if (L_{RBs}−1)≥└N_{BWP}^{size}/2┘ then

RIV=N_{BWP}^{size}(L_{RBs}−1)+RBₛₜₐᵣₜ

else

RIV=N_{BWP}^{size}(N_{BWP}^{size}−L_{RBs}+1)+(N_{BWP}^{size}−1−RBₛₜₐᵣₜ)

In the TDD and FDD standards, regardless of a frequency domain resource allocation manner of Type0 or Type1, a terminal determines, based on the size of the BWP, RB_start for data transmission or reception. For a BWP, the number of downlink or uplink RBs included in the BWP remains unchanged in different time units.

Frequency hopping manner for data transmission

Intra-slot Frequency Hopping (FH)

Intra-slot frequency hopping means that frequency hopping occurs in each slot, and is applicable to transmission of a single-slot PUSCH and a multi-slot PUSCH (configured by a higher layer, for example, PUSCH with configured grant, or dynamically scheduled, for example, PUSCH scheduled by DCI), where the multi-slot PUSCH includes:

PUSCH repetition Type A;

TB processing over multiple slots; and

transmission of multiple PUSCHs, where the multiple PUSCHs carry different TBs to be transmitted in different slots. For a dynamically scheduled PUSCH, a parameter pusch-TimeDomainAllocationListForMultiPUSCH is configured by the higher layer, and for a configured grant PUSCH, parameters cg-nrofSlots and cg-nrofPUSCH-InSlot are configured by the higher layer.

In case of intra-slot frequency hopping, the starting RB in each hop is given by:

$${RB}_{start} = \{ \begin{matrix}{RB}_{start} & i = 0 \\ ( {RB}_{start} + {RB}_{offset} ) mod {N}_{BWP}^{size} & i = 1\end{matrix} ,$$

where i=0 and i=1 are the first hop and the second hop respectively, and RBₛₜₐᵣₜ is the starting RB within the UL BWP, as calculated from the resource block assignment information of resource allocation type 1 (described in Clause 6.1.2.2.2) or as calculated from the resource assignment for MsgA PUSCH (described in [6, TS 38.213]) and RB_{offset} is the frequency offset in RBs between the two frequency hops. The number of symbols in the first hop is given by └N_{symb}^{PUSCH,s}/2┘, where the number of symbols in the second hop is given by N_{symb}^{PUSCH,s}−└N_{symb}^{PUSCH,s}/2┘, where N_{symb}^{PUSCH,s} is the length of the PUSCH transmission in OFDM symbols in one slot.

Un-enabled inter-slot frequency hopping (PUSCH-DMRS-Bundling (inter-slot FH))

Un-enabled inter-slot frequency hopping means that the frequency hopping occurs between every two slots, and is applicable to transmission of a multi-slot PUSCH (configured by a higher layer, for example, PUSCH with configured grant, or dynamically scheduled, for example, PUSCH scheduled by DCI), where the multi-slot PUSCH includes:

PUSCH repetition Type A and PUSCH repetition Type B;

TB processing over multiple slots; and

transmission of multiple PUSCHs, where the multiple PUSCHs carry different TBs to be transmitted in different slots.

For the dynamically scheduled PUSCH, a parameter pusch-TimeDomainAllocationListForMultiPUSCH is configured by the higher layer, and for the configured grant PUSCH, parameters cg-nrofSlots and cg-nrofPUSCH-InSlot are configured by the higher layer.

multi-slot PUSCH transmission

In case of inter-slot frequency hopping, the starting RB during slot nₛ^{μ} is given by:

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} ,$$

where nₛ^{μ} is the current slot number within a radio frame, where a multi-slot PUSCH transmission can take place, RBₛₜₐᵣₜ is the starting RB within the UL BWP, as calculated from the resource block assignment information of resource allocation type 1 (described in Clause 6.1.2.2.2) and RB_{offset} is the frequency offset in RBs between the two frequency hops.

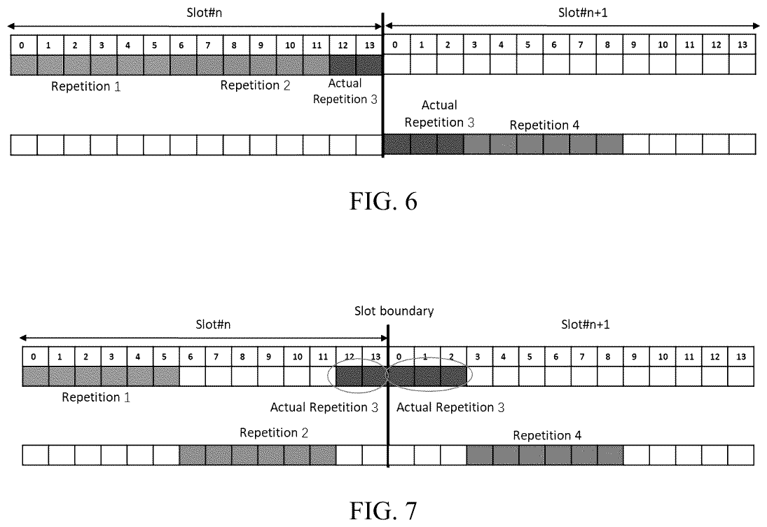

FIG. 6 is a schematic diagram of transmission of an un-enabled inter-slot frequency hopping type B according to an embodiment of this application. As shown in FIG. 6, slot numbers start from 0.

nₛ^{u}mod 2=0 indicates that uplink data/control information/signals transmitted on an even-numbered slot are the same in terms of frequency domain locations, and a start location is configured/indicated by a network, and is referred to as a first hop.

nₛ^{u}mod 2=1 indicates that uplink data/control information/signals transmitted on an odd-numbered slot are the same in terms of frequency domain locations, and a start location is configured/indicated by a network+a frequency offset (RB offset), and is referred to as a second hop.

Inter-slot frequency hopping (inter-slot FH) after PUSCH-DMRS-Bundling is enabled

Enabled inter-slot frequency hopping is used to indicate that frequency hopping occurs between every two frequency hopping intervals (N_FH), and is applicable to transmission of a multi-slot PUSCH (configured by a higher layer, for example, PUSCH with configured grant, or dynamically scheduled, for example, PUSCH scheduled by DCI), where the multi-slot PUSCH includes:

PUSCH repetition Type A and PUSCH repetition Type B;

TB processing over multiple slots; and

transmission of multiple PUSCHs, where the multiple PUSCHs carry different TBs to be transmitted in different slots. For a dynamically scheduled PUSCH, a parameter pusch-TimeDomainAllocationListForMultiPUSCH is configured by the higher layer, and for a configured grant PUSCH, parameters cg-nrofSlots and cg-nrofPUSCH-InSlot are configured by the higher layer.

multi-slot PUSCH transmission

In case of inter-slot frequency hopping and when PUSCH-DMRS-Bundling is enabled, and when a PUSCH is not scheduled by RAR UL grant or DCI format 0_0 with CRC scrambled by TC-RNTI, the starting RB during skot nₛ^{u} is given by:

$$[ {RB}_{start} ( {n}_{s , f}^{μ} ) = \{ \begin{matrix}{RB}_{start} & [ \frac{\text{?} + \text{?} \cdot {N}_{slot}^{frame , μ}}{\text{?}} ] mod 2 = 0 \\ ( {RB}_{start} + {RB}_{offset} ) mod {N}_{BWP}^{size} & [ \frac{\text{?} + \text{?} \cdot {N}_{slot}^{frame , μ}}{\text{?}} ] mod 2 = \text{?}\end{matrix} ]$$

$$\text{?} \text{indicates text missing or illegible when filed}$$

where n_{s,f}^{μ} is the current slot number within a system radio frame, n_{f} is the number of the system radio frame containing the current slot. Nₛₗₒₜ^{frame,μ} is the number of slots per frame for subcarrier spacing configuration μ of the UL BWP that the PUSCH is transmitted on. N_{FH} is the value of the higher layer parameter PUSCH-Frequencyhopping-Interval, RBₛₜₐᵣₜ is the starting RB within the UL BWP, as calculated from the resource block assignment information of resource allocation type 1 (described in Clause 6.1.2.2.2) and RB_{offset} is the frequency offset in RBs between the two frequency hops.

Inter-repetition frequency hopping mechanism (Inter-repetition FH)

The inter-repetition frequency hopping mechanism is used to indicate that frequency hopping occurs between every to nominal repetitions, where

inter-repetition FH is only applicable to PUSCH repetition Type B.

In case of inter-repetition frequency hopping, the starting RB for an actual repetition within the n-th nominal repetition (as defined in Clause 6.1.2.1) is given by:

$${RB}_{start} ( n ) = \{ \begin{matrix}{RB}_{start} & n mod 2 = 0 \\ ( {RB}_{start} + {RB}_{offset} ) mod {N}_{BWP}^{size} & n mod 2 = 1\end{matrix} ,$$

where RBₛₜₐᵣₜ is the starting RB within the UL BWP, as calculated from the resource block assignment information of resource allocation type 1 (described in Clause 6.1.2.2.2) and RBoffset is the frequency offset in RBs between the two frequency hops.

FIG. 7 is a schematic diagram of transmission of an enabled inter-slot frequency hopping type B according to an embodiment of this application, as shown in FIG. 7.

Repetition numbers start from 0.

n mod 2=0 indicates that uplink data/control information/signals transmitted in an even-numbered repetition are the same in terms of frequency domain locations, and a start location is configured/indicated by a network, and is referred to as a first hop.

n mod 2=1 indicates that uplink data/control information/signals transmitted in an odd-numbered repetition are the same in terms of frequency domain locations, and a start location is configured/indicated by a network+a frequency offset (RB offset), and is referred to as a second hop.

Currently, a flexible/full duplex network supports the following case: On asymmetric spectrums, there can be both a downlink resource and an uplink resource at a same moment/in a same time unit, and at different moments/in different time units, a downlink resource and an uplink resource can be different in terms of frequency domain locations (that is, a start physical resource block and an end physical resource block) and sizes, that is, the number of occupied RBs. Therefore, a method is required to enable a terminal to determine a start RB of uplink data/signal transmitted by the terminal or downlink data/signal received by the terminal.

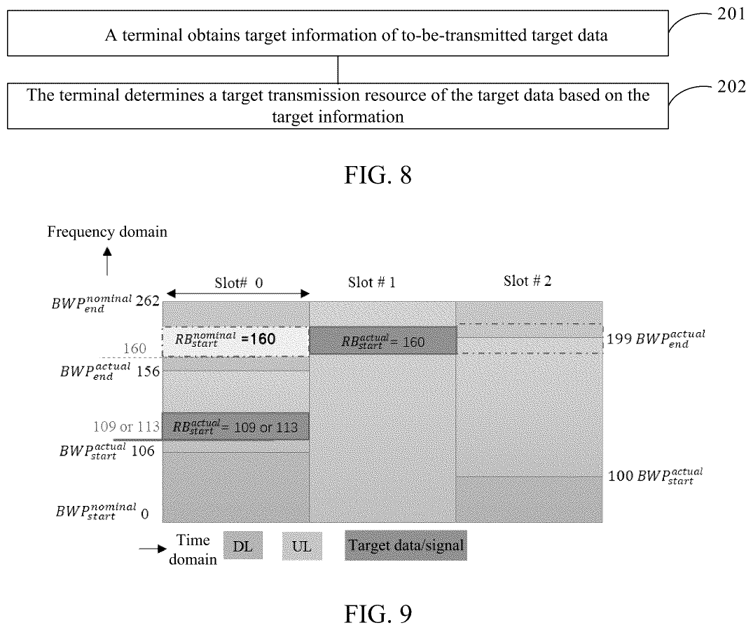

A determining method is provided in an embodiment of this application. FIG. 8 is a flowchart of a determining method according to an embodiment of this application. As shown in FIG. 8, the determining method provided in this embodiment of this application may include the following step 201 and step 202.

Step 201: A terminal obtains target information of to-be-transmitted target data.

The target information is information related to transmission of the target data.

For example, in this embodiment of this application, the target information includes at least one of the following:
first information, used to indicate a length of a reference frequency domain resource for transmission of the target data, a start RB of the reference frequency domain resource, or an end RB of the reference frequency domain resource;
second information, used to indicate a length of an actual frequency domain resource for transmission of the target data, a start RB of the actual frequency domain resource, or an end RB of the actual frequency domain resource;
third information, used to indicate a type of a time unit for transmission of the target data;
fourth information, used to indicate a data type of the target data;
fifth information, used to indicate a transmission type of the target data;
sixth information, used to indicate an allocation type of a frequency domain resource for transmission of the target data; and
seventh information, used to indicate a frequency domain offset of transmission of the target data.

For example, in this embodiment of this application, the first information is determined by at least one of the following:
first bandwidth part information, used to indicate a length of a current active uplink bandwidth part, a start RB of the active uplink bandwidth part, or an end RB of the active uplink bandwidth part;
second bandwidth part information, used to indicate a length of a current active downlink bandwidth part, a start RB of the active downlink bandwidth part, or an end RB of the active downlink bandwidth part;
third bandwidth part information, used to indicate a length of an initial uplink bandwidth part, a start RB of the initial uplink bandwidth part, or an end RB of the initial uplink bandwidth part;
fourth bandwidth part information, used to indicate a length of an initial downlink bandwidth part, a start RB of the initial downlink bandwidth part, or an end RB of the initial downlink bandwidth part;
information about a control resource set, used to indicate a frequency domain length of the control resource set, a frequency domain starts RB of the control resource set, or a frequency domain end RB of the control resource set;
first sub-band information, used to indicate a length of an uplink sub-band in a flexible duplex standard, a start RB of the uplink sub-band in the flexible duplex standard, or an end RB of the uplink sub-band in the flexible duplex standard; and
second sub-band information, used to indicate a length of a downlink sub-band in the flexible duplex standard, a start RB of the downlink sub-band in the flexible duplex standard, or an end RB of the downlink sub-band in the flexible duplex standard; or
the first information is configured and/or indicated by a network side device.

For example, in this embodiment of this application, being configured or indicated by the network side device may be understood as that the network side device configures and/or indicates a length of a frequency domain resource, a start RB of the frequency domain resource, or an end RB of the frequency domain resource.

For example, in this embodiment of this application, the network side device may directly configure or indicate a length of a frequency domain resource, a start RB of the frequency domain resource, or an end RB of the frequency domain resource.

For example, in this embodiment of this application, the network side device may configure lengths of multiple frequency domain resources, start RBs of the frequency domain resources, or end RBs of the frequency domain resources. Further, the network side device may indicate a length of one of the multiple frequency domain resources, a start RB of the frequency domain resource, or an end RB of the frequency domain resource in the configured lengths of the multiple frequency domain resources, start RBs of the frequency domain resources, or end RBs of the frequency domain resources.

For example, in this embodiment of this application, the network side device may configure and/or indicate information about the reference frequency domain resource.

For example, the network side device may configure and/or indicate that the length of the reference frequency domain resource is the length of the current active uplink bandwidth part, the start RB of the reference frequency domain resource is the start RB of the current active uplink bandwidth part, and the end RB of the reference frequency domain resource is the end RB of the current active uplink bandwidth part.

For example, the network side device may configure and/or indicate that the length of the reference frequency domain resource is the length of the current active downlink bandwidth part, the start RB of the reference frequency domain resource is the start RB of the current active downlink bandwidth part, and the end RB of the reference frequency domain resource is the end RB of the current active downlink bandwidth part.

For example, the network side device may configure and/or indicate that the length of the reference frequency domain resource is the length of the initial uplink bandwidth part, the start RB of the reference frequency domain resource is the start RB of the initial uplink bandwidth part, and the end RB of the reference frequency domain resource is the end RB of the initial uplink bandwidth part.

For example, the network side device may configure and/or indicate that the length of the reference frequency domain resource is the length of the initial downlink bandwidth part, the start RB of the reference frequency domain resource is the start RB of the initial downlink bandwidth part, and the end RB of the reference frequency domain resource is the end RB of the initial downlink bandwidth part.

For example, the network side device may configure and/or indicate that the length of the reference frequency domain resource is the length of the uplink sub-band in the flexible duplex standard, the start RB of the reference frequency domain resource is the start RB of the uplink sub-band in the flexible duplex standard, and the end RB of the reference frequency domain resource is the end RB of the uplink sub-band in the flexible duplex standard.

For example, the network side device may configure and/or indicate that the length of the reference frequency domain resource is the length of the downlink sub-band in the flexible duplex standard, the start RB of the reference frequency domain resource is the start RB of the downlink sub-band in the flexible duplex standard, and the end RB of the reference frequency domain resource is the end RB of the downlink sub-band in the flexible duplex standard.

For example, in this embodiment of this application, the control resource set is a control resource set configured by a serving cell of the terminal for the terminal, or is a control resource set with an index of 0 of the terminal.

For example, in this embodiment of this application, if a control resource set (that is, CORESET0) is configured by a current serving cell of the terminal, the terminal uses a length of a frequency domain resource occupied by CORESET0, a start RB of the frequency domain resource occupied by CORESET0, and an end RB of the frequency domain resource occupied by CORESET0; otherwise, the terminal uses the length of the initial downlink bandwidth part, the start RB of the initial downlink bandwidth part, or the end RB of the initial downlink bandwidth part.

For example, in this embodiment of this application, the second information is determined by at least one of the following:
first frequency domain resource information, used to indicate a length of an available frequency domain of the target data, a start RB of the available frequency domain resource, or an end RB of the available frequency domain resource;
third sub-band information, used to indicate a length of an uplink sub-band, a start RB of the uplink sub-band, or an end RB of the uplink sub-band;
fourth sub-band information, used to indicate a length of a downlink sub-band, a start RB of the downlink sub-band, or an end RB of the downlink sub-band; and
second frequency domain resource information, used to indicate a length of a current active BWP minus a length of a frequency domain resource corresponding to an unavailable frequency domain resource of the target data, a start RB of the active BWP, or an end RB of the active BWP, where a RB of a frequency domain resource corresponding to a start RB of the unavailable frequency domain resource of the target data is an end RB of an actual frequency resource, or a RB of a frequency domain resource corresponding to an end RB of the unavailable frequency domain resource of the target data is a start RB of the actual frequency resource.

For example, in this embodiment of this application, the available frequency domain resource is a frequency domain resource whose transmission direction is the same as a transmission direction of the target data, and the unavailable frequency domain resource is a frequency domain resource whose transmission direction is different from the transmission direction of the target data;

or

the available frequency domain resource is a frequency domain resource whose transmission direction is not opposite to a transmission direction of the target data, and the unavailable frequency domain resource is a frequency domain resource whose transmission direction is opposite to the transmission direction of the target data.

For example, if the transmission direction of the available frequency domain resource is uplink transmission, and the transmission direction of the target data is uplink transmission, the available frequency domain resource is a frequency domain resource whose transmission direction is the same as the transmission direction of the target data.

For example, if the transmission direction of the available frequency domain resource is uplink transmission, a flexible direction, or guard band transmission, and the transmission direction of the target data is uplink transmission, the unavailable frequency domain resource is a frequency domain resource whose transmission direction is different from the transmission direction of the target data.

For example, if the transmission direction of the available frequency domain resource is downlink transmission, a flexible direction, or guard band transmission, and the transmission direction of the target data is uplink transmission, the available frequency domain resource is a frequency domain resource whose transmission direction is not opposite to the transmission direction of the target data.

For example, if the transmission direction of the available frequency domain resource is downlink transmission and the transmission direction of the target data is uplink transmission, the unavailable frequency domain resource is a frequency domain resource whose transmission direction is opposite to the transmission direction of the target data.

For example, in this embodiment of this application, the third information includes at least one of the following:
first time unit information, used to indicate a time unit with no conflict in an uplink direction of the target data;
second time unit information, used to indicate a time unit with no conflict in a downlink direction of the target data;
third time unit information, used to indicate a time unit on an uplink;
fourth time unit information, used to indicate a time unit on a downlink;
fifth time unit information, used to indicate a time unit on an uplink sub-band;
sixth time unit information, used to indicate a time unit on a downlink sub-band;
seventh time unit information, used to indicate a time unit in which no sub-band full-duplex SBFD exists; and
eighth time unit information, used to indicate a time unit in which SBFD exists.

For example, in this embodiment of this application, the time unit includes at least one slot or at least one orthogonal frequency division multiplexing OFDM symbol.

For example, in this embodiment of this application, the fourth information is determined by at least one of the following:
being determined by using downlink control information DCI in common search space;
being determined by using DCI in dedicated search space; and
being configured by a network side device.

For example, “being determined by using downlink control information DCI in common search space” may be: being determined by downlink control information DCI formats 0_0 and 0_1 in the common search space.

For example, in this embodiment of this application, the fifth information includes at least one of the following:
first-type information, used to indicate a single-slot transmission type; and
second-type information, used to indicate a multi-slot transmission type.

For example, in this embodiment of this application, when the fifth information includes the first-type information, the length of the reference frequency domain resource for transmission of the target data is a length of the reference frequency domain resource that is determined based on the first-type information, the start RB of the reference frequency domain resource is a start RB of the reference frequency domain resource that is determined based on the first-type information, and the end RB of the reference frequency domain resource is an end RB of the reference frequency domain resource that is determined based on the first-type information.

For example, in this embodiment of this application, when the fifth information includes the second-type information, the length of the reference frequency domain resource for transmission of the target data is a length of the reference frequency domain resource that is determined by the terminal based on target slot information, the start RB of the reference frequency domain resource is a start RB of the reference frequency domain resource that is determined by the terminal based on the target slot information, and the end RB of the reference frequency domain resource is an end RB of the reference frequency domain resource that is determined by the terminal based on the target slot information.

The target slot information is a slot in which first nominal transmission of the multi-slot transmission type indicated by the second-type information is located, or is a slot in which first actual transmission of the multi-slot transmission type is located.

For example, in this embodiment of this application, the seventh information is configured and/or indicated by the network side device.

For example, in this embodiment of this application, the network side device may configure and/or indicate frequency domain offsets of transmission of N pieces of target data for the terminal, where N is an integer greater than or equal to 1.

Step 202: The terminal determines a target transmission resource of the target data based on the target information.

In this embodiment of this application, the target transmission resource includes a target start resource block RB.

A determining method is provided in this embodiment of this application. The terminal obtains the target information of the to-be-transmitted target data, where the target information is information related to transmission of the target data; and determines the target transmission resource of the target data based on the target information, where the target transmission resource includes the target start resource block RB. The terminal can obtain the target information related to the to-be-transmitted target data, so that the terminal can determine, based on the target information, the target transmission resource used to transmit the target data, that is, can determine the target start resource block RB.

For example, in this embodiment of this application, after the terminal determines the target transmission resource of the target data based on the target information, the terminal may transmit the target data based on the determined target transmission resource.

For example, in this embodiment of this application, the target start RB includes a reference start RB, the target information includes the first information and the sixth information, and step 202 may be implemented by using the following step 202a.

Step 202a: The terminal determines the reference start RB based on the first information and the sixth information.

For example, in this embodiment of this application, step 202a may be implemented by the following step 202a1.

Step 202a1: The terminal determines the reference start RB based on the length of the reference frequency domain resource and a target allocation manner, where the target allocation manner is an allocation manner corresponding to the allocation type indicated by the sixth information.

For example, the terminal may determine the reference start RB and the actual number, that is, NRB, of RBs for transmission of the target data based on the length of the reference frequency domain resource and according to the target allocation manner, that is, Type0 or Type1, and in a frequency domain resource allocation manner of Type0 or the Type1.

$${RB}_{end}^{nominal} = {RB}_{start}^{nominal} + {N}_{RB} - 1 .$$

For example, in this embodiment of this application, the target start RB includes an actual start RB, the target information includes the first information, the second information, and the seventh information, and step 202 may be implemented by using the following step 202b.

Step 202b: The terminal determines the actual start RB based on the first information, the second information, and the seventh information.

For example, in this embodiment of this application, step 202b may be implemented by the following step 202b1, step 202b2, or step 202b3.

Step 202b1: In a case that the length of the reference frequency domain resource for transmission of the target data is greater than or equal to the length of the actual frequency domain resource for transmission of the target data and the reference start RB is greater than or equal to the end RB of the actual frequency domain resource for the transmission of the target data, the terminal determines the start RB based on a difference between the reference start RB and the frequency domain offset of transmission of the target data, or determines the start RB based on the start RB of the actual frequency domain resource for the transmission of the target data and the first information, where the first information is a value obtained by performing a modulo operation on the reference start RB and the length of the reference frequency domain resource for transmission of the target data.

For example, in this embodiment of this application,

in a case that N_{BWP,nominal}^{size}≥N_{BWP,actual}^{size} and RBₛₜₐᵣₜ^{nominal}≥BWP_{end}^{actual}, RBₛₜₐᵣₜ^{actual}=RBₛₜₐᵣₜ^{nominal}−RB_{offset}⁽ⁱ⁾, or RBₛₜₐᵣₜ^{actual}+(RBₛₜₐᵣₜ^{nominal})modN_{BWP,actual}^{size}.

Step 202b2: In a case that the length of the reference frequency domain resource for transmission of the target data is greater than or equal to the length of the actual frequency domain resource for transmission of the target data and the reference start RB is less than or equal to the end RB of the actual frequency domain resource for the transmission of the target data, the terminal determines the start RB based on a value of a sum of the reference start RB and the frequency domain offset of transmission of the target data, or determines the start RB based on the start RB of the actual frequency domain resource for the transmission of the target data and the first information.

For example, in this embodiment of this application,

in a case that N_{BWP,nominal}^{size}≥N_{BWP,actual}^{size} and RBₛₜₐᵣₜ^{nominal}≥BWP_{end}^{actual}, RBₛₜₐᵣₜ^{actual}=RBₛₜₐᵣₜ^{nominal}+RB_{offset}⁽ⁱ⁾, or RBₛₜₐᵣₜ^{actual}=BWPₛₜₐᵣₜ^{actual}+(RBₛₜₐᵣₜ^{nominal})modN_{BWP,actual}^{size}.

Step 202b3: In a case that the length of the reference frequency domain resource for transmission of the target data is greater than or equal to the length of the actual frequency domain resource for transmission of the target data and the reference start RB is less than or equal to the end RB of the actual frequency domain resource for the transmission of the target data and is greater than or equal to the start RB of the actual frequency domain resource for the transmission of the target data, the terminal determines the start RB based on the reference start RB, or determines the start RB based on the start RB of the actual frequency domain resource for the transmission of the target data and the first information.

For example, in this embodiment of this application,

in a case that N_{BWP,nominal}^{size}≥N_{BWP,actual}^{size} and BWPₛₜₐᵣₜ^{actual}≤RBₛₜₐᵣₜ^{nominal}≤BWP_{end}^{actual}, RBₛₜₐᵣₜ^{actual}=RBₛₜₐᵣₜ^{nominal}, or RBₛₜₐᵣₜ^{actual}=BPWₛₜₐᵣₜ^{actual}+(RBₛₜₐᵣₜ^{nominal})modN_{BWP,actual};

where

a reference start RB occupied for transmission of the target data is RBₛₜₐᵣₜ^{nominal};

an actual start RB occupied for transmission of the target data is RBₛₜₐᵣₜ^{actual};

a nominal end RB occupied for transmission of the target data is denoted as RB_{end}^{nominal};

an actual end RB occupied for transmission of the target data is denoted as RB_{end}^{actual};

the number of actual RBs occupied for transmission of the target data is denoted as N_{RB};

N pieces of frequency domain offset information of the target data are denoted as RB_{offset}⁽ⁿ⁾;

length information of a nominal frequency domain resource for the transmission of the target data is denoted as N_{BWP,nominal}^{size};

size information of an actual frequency domain resource for the transmission of the target data is denoted as N_{BWP,actual}^{size};

a start RB of the nominal frequency domain resource for the transmission of the target data is denoted as BWPₛₜₐᵣₜ^{nominal};

an end RB of the nominal frequency domain resource for the transmission of the target data is denoted as BWP_{end}^{nominal};

a start RB of the actual frequency domain resource for the transmission of the target data is denoted as BWPₛₜₐᵣₜ^{actual}; and

an end RB of the actual frequency domain resource for the transmission of the target data is denoted as BWP_{end}^{actual};

It should be noted that in this embodiment of this application, meanings expressed by nominal, reference, or virtual are the same, and usage of nominal, reference, or virtual may be exchanged. In this embodiment of this application, meanings expressed by actual (including actual) or available (including available) are the same, and usage of actual and available may be exchanged.

For example, as shown in FIG. 9, N_{BWP,nominal}^{size}≥N_{BWP,actual}^{size}.

If N_{BWP,nominal}^{size}=263, BWPₛₜₐᵣₜ^{nominal}=0, and BWP_{end}^{nominal}=262,

for slot #0, N_{BWP,actual}^{size}=51, BWPₛₜₐᵣₜ^{actual}=106, and BWP_{end}^{actual}=156;

for slot #1, N_{BWP,actual}^{size}=263, BWPₛₜₐᵣₜ^{actual}=0, and BWP_{end}^{actual}=262;

for slot #2, N_{BWP,actual}^{size}=100, BWPₛₜₐᵣₜ^{actual}=100, and BWP_{end}^{actual}=199.

Based on the length of the reference frequency domain resource for transmission of the target data, the start RB of the reference frequency domain resource, or the end RB of the reference frequency domain resource, and Frequency domain resource assignment (FDRA) configured by the network side device for the target data or indicated in the DCI, it is determined that RBₛₜₐᵣₜ^{nominal}=160. The target data occupies 12 consecutive RBs.

If RB_{offset}⁽ⁱ⁾=51,

for slot #0, RBₛₜₐᵣₜ^{nominal}>BWP_{end}^{actual}, and RBₛₜₐᵣₜ^{actual}=RBₛₜₐᵣₜ^{nominal}−RB_{offset}⁽ⁱ⁾=160−51=109;

or

RBₛₜₐᵣₜ^{actual}=BWPₛₜₐᵣₜ^{actual}+(RBₛₜₐᵣₜ^{nominal})modN_{BWP,actual}^{size}=160+(160)mod(51)=113

for slot #1, N_{BWP,nominal}^{size}=N_{BWP,actual}^{size}; and

RBₛₜₐᵣₜ^{actual}=RBₛₜₐᵣₜ^{nominal}=160

for slot #2, RB_{end}^{nominal}>BWP_{end}^{actual}, and RBₛₜₐᵣₜ^{actual}≥BWP_{end}^{actual}.

The terminal does not expect that the foregoing situation occurs in the target data configured or scheduled by the network side device, or the terminal abandons transmission or reception of the target data.

For example, in this embodiment of this application, the determining method provided in this embodiment of this application further includes the following step 202b4.

Step 202b4: In a case that the length of the reference frequency domain resource for transmission of the target data is less than or equal to the length of the actual frequency domain resource for transmission of the target data, the terminal determines the start RB based on a difference between the reference start RB and the frequency domain offset of transmission of the target data, or the terminal determines the start RB based on a value of a sum of the reference start RB and the frequency domain offset of transmission of the target data, or determines the start RB based on the start RB of the actual frequency domain resource for the transmission of the target data and the first information.

In a case that N_{BWP,nominal}^{size}<N_{BWP,actual}^{size},

RBₛₜₐᵣₜ^{actual}=RBₛₜₐᵣₜ^{nominal}−RB_{offset}⁽ⁱ⁾; or

RBₛₜₐᵣₜ^{actual}=RBₛₜₐᵣₜ^{nominal}+RB_{offset}⁽ⁱ⁾; or

RBₛₜₐᵣₜ^{actual}=BWPₛₜₐᵣₜ^{actual}+(RBₛₜₐᵣₜ^{nominal})modN_{BWP,actual}^{size}.

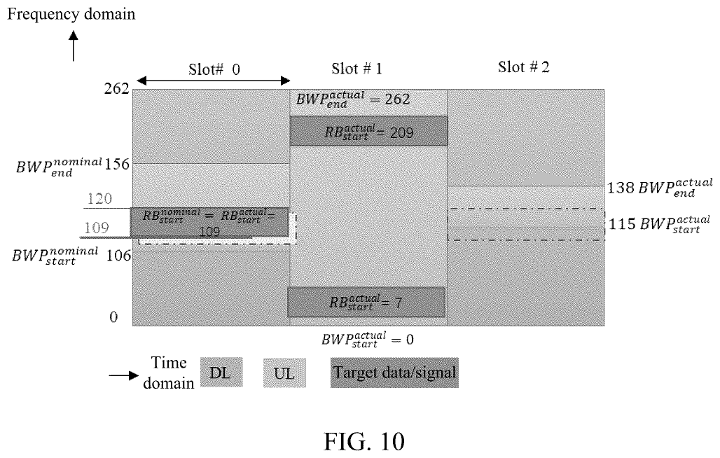

For example, as shown in FIG. 10, N_{BWP,nominal}^{size}≤N_{BWP,actual}^{size}.

If N_{BWP,nominal}^{size}=51, BWPₛₜₐᵣₜ^{nominal}=106, and BWP_{end}^{nominal}=156,

for slot #0, N_{BWP,actual}^{size}=51, BWPₛₜₐᵣₜ^{actual}=106, and BWP_{end}^{actual}=156;

for slot #1, N_{BWP,actual}^{size}=263, BWPₛₜₐᵣₜ^{actual}=0, and BWP_{end}^{actual}=262; and

for slot #2, N_{BWP,actual}^{size}=24, BWPₛₜₐᵣₜ^{actual}=115, and BWP_{end}^{actual}=138.

Based on the length of the reference frequency domain resource for transmission of the target data, the start RB of the reference frequency domain resource, or the end RB of the reference frequency domain resource, and Frequency domain resource assignment (FDRA) configured by the network side device for the target data or indicated in the DCI, it is determined that RBₛₜₐᵣₜ^{nominal}=109. The target data occupies 12 consecutive RBs.

If RB_{offset}⁽ⁱ⁾=51, and RB_{offset}^{(j)}=109,

for slot #0, N_{BWP,nominal}^{size}=N_{BWP,actual}^{size}, and RBₛₜₐᵣₜ^{actual}=RBₛₜₐᵣₜ^{nominal}=109;

for slot #1, N_{BWP,nominal}^{size}<N_{BWP,actual}^{size}, and

RBₛₜₐᵣₜ^{actual}=BWPₛₜₐᵣₜ^{actual}+(RBₛₜₐᵣₜ^{nominal})modN_{BWP,actual}^{size}=0+(109)mod(51)=7; and

for slot #2, RB_{end}^{nominal}≤BWP_{end}^{actual}, and RBₛₜₐᵣₜ^{actual}>BWP_{end}^{actual}.

The terminal does not expect that the foregoing situation occurs in the target data configured or scheduled by the network side device, or the terminal abandons transmission or reception of the target data.

It should be noted that data transmitted in the foregoing example in step 202b1 and the foregoing example in step 202b2 may be single-slot transmission or multi-slot transmission.

Single-slot transmission means that data transmitted in slot #0 and slot #1 may be

different TBs, and are configured by respective higher layers or scheduled by DCI.

Multi-slot transmission includes at least one of the following:

PUSCH repetition Type A and PUSCH repetition Type B;

TB processing over multiple slots; and

transmission of multiple PUSCHs, where the multiple PUSCHs carry different TBs to be transmitted in different slots.

For the dynamically scheduled PUSCH, a parameter pusch-TimeDomainAllocationListForMultiPUSCH is configured by the higher layer, and for the configured grant PUSCH, parameters cg-nrofSlots and cg-nrofPUSCH-InSlot are configured by the higher layer.

For example, for multi-slot transmission, if the length of the reference frequency domain resource for transmission of the target data is determined by the length of the uplink sub-band in the flexible duplex standard, the start RB of the reference frequency domain resource is determined by the start RB of the uplink sub-band in the flexible duplex standard, and the end RB of the reference frequency domain resource is determined by the end RB of the uplink sub-band in the flexible duplex standard, multi-slot transmission is data transmission in four slots, where transmission of the target data in slot #0 is transmission on the reference frequency domain resource, which is also referred to as a physical frequency domain resource. To be specific, the target data may not be transmitted in slot #0 for some reasons specified in a protocol, for example, in a same slot, a transmission direction of the target data is conflict with a transmission direction indicated and configured by a network or with measurement, transmission, reception, and the like of other data in terms of time domain and/or frequency domain resources, and consequently, the target data is not transmitted in this slot. The target data is actually transmitted in slot #1, that is, the target data is transmitted in slot #1, and no target data/signal is dropped.

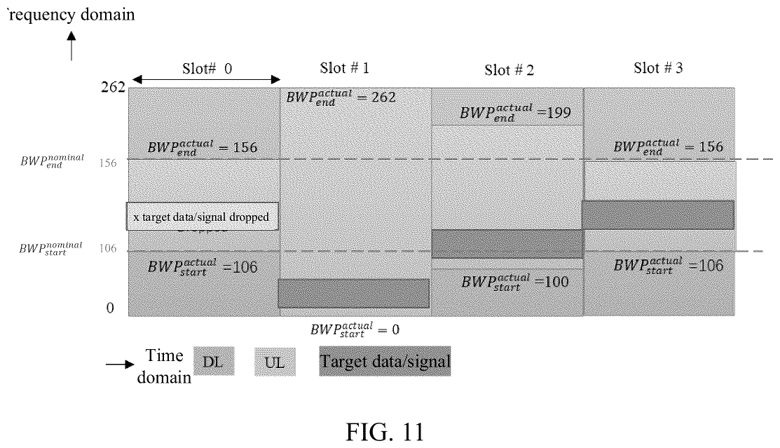

For example, as shown in FIG. 11, for multi-slot transmission, if the length of the reference frequency domain resource for transmission of the target data is determined by the length determined by the target slot information, the start RB of the reference frequency domain resource is determined based on the target slot information, and the end RB of the reference frequency domain resource is determined based on the target slot information, where the target slot information is a slot in which first nominal transmission of the multi-slot transmission type indicated by the second-type information is located, or is a slot in which first actual transmission of the multi-slot transmission type is located, a length of a reference frequency domain resource of the target resource in each of multiple slots, a start RB of the reference frequency domain resource, and an end RB of the reference frequency domain resource are a length, a start RB, and nominal an end RB of an uplink sub-band in slot #0, that is, N_{BWP,nominal}^{size}=51, BWPₛₜₐᵣₜ^{nominal}=106, and BWP_{end}^{nominal}=156.

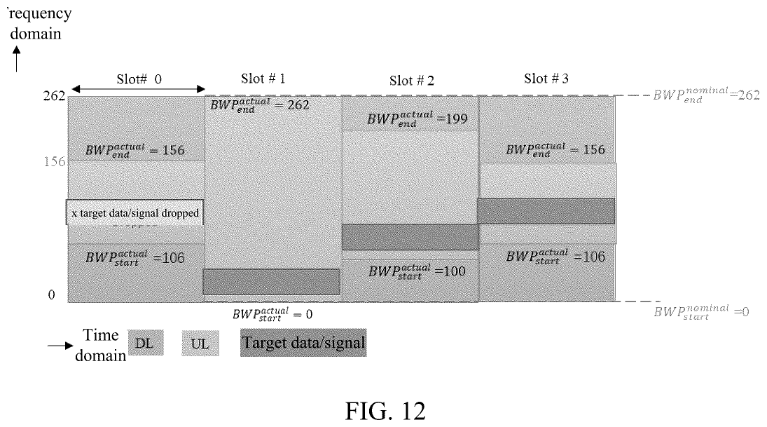

For example, as shown in FIG. 12, for multi-slot transmission, if the length of the reference frequency domain resource for transmission of the target data is determined by the length determined by the target slot information, the start RB of the reference frequency domain resource is determined based on the target slot information, and the end RB of the reference frequency domain resource is determined based on the target slot information, where the target slot information is a slot in which first nominal transmission of the multi-slot transmission type indicated by the second-type information is located, or is a slot in which first actual transmission of the multi-slot transmission type is located, a length of a reference frequency domain resource of the target resource in each of multiple slots, a start RB of the reference frequency domain resource, and an end RB of the reference frequency domain resource are a length, a start RB, and an end RB of an uplink sub-band in slot #1, that is, N_{BWP,nominal}^{size}=263, BWPₛₜₐᵣₜ^{nominal}=106, and BWP_{end}^{nominal}=156.

For example, in this embodiment of this application, the determining method provided in this embodiment of this application further includes the following step 301 or step 302.

Step 301: The terminal does not expect a first condition to be met.

Step 302: In a case that the first condition is met, the terminal abandons transmission of the target data.

The first condition is: the reference start RB is greater than or equal to the end RB of the actual frequency domain resource for the transmission of the target data, and the reference start RB is less than or equal to the end RB of the actual frequency domain resource for the transmission of the target data;

or

the reference start RB is greater than or equal to the start RB of the actual frequency domain resource for the transmission of the target data, and the reference start RB is less than or equal to the start RB of the actual frequency domain resource for the transmission of the target data.

For example, in this embodiment of this application, the first condition is:

RB_{end}^{nominal}>BWP_{end}^{actual}; and RBₛₜₐᵣₜ^{nominal}≤BWP_{end}^{actual}; or

RBₛₜₐᵣₜ^{nominal}<BWPₛₜₐᵣₜ^{actual}; and RB_{end}^{nominal}≥BWPₛₜₐᵣₜ^{actual}.

For example, in this embodiment of this application, the determining method provided in this embodiment of this application further includes step 401.

Step 401: In a case that frequency hopping transmission is enabled by transmission of the target data, the terminal determines start location information of each frequency hopping transmission.

For example, in this embodiment of this application, for intra-slot frequency hopping, inter-slot frequency hopping with un-enabled PUSCH-DMRS-Bundling, inter-slot frequency hopping with enabled PUSCH-DMRS-Bundling, or inter-repetition frequency hopping (Inter-repetition FH), RBₛₜₐᵣₜ in the formulas is replaced with RBₛₜₐᵣₜ^{actual}, and N_{BWP}^{size} is replaced with N_{BWP,actual}^{size}.

The determining method provided in the embodiments of this application may be performed by a determining apparatus. In the embodiments of this application, that the determining apparatus performs the determining method is used as an example to describe the determining apparatus provided in the embodiments of this application.

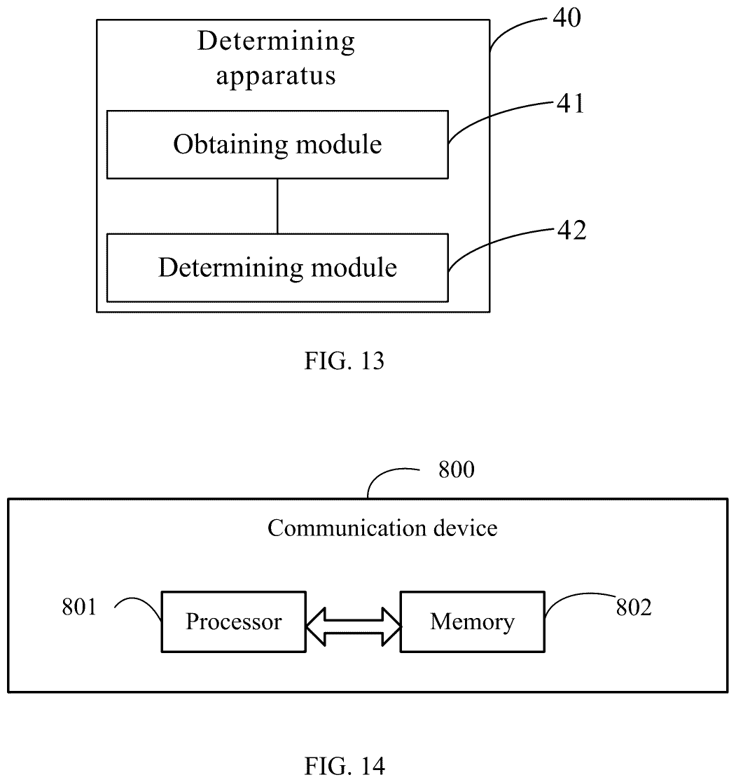

FIG. 13 is a possible schematic diagram of a structure of a determining apparatus for an Internet of things device according to an embodiment of the application. As shown in FIG. 13, a determining apparatus 40 may include an obtaining module 41 and a determining module 42.

The obtaining module 41 is configured to obtain target information of to-be-transmitted target data, where the target information is information related to transmission of the target data. The determining module 42 is configured to determine a target transmission resource of the target data based on the target information, where the target transmission resource includes a target start resource block RB.

A determining apparatus is provided in this embodiment of this application. The determining apparatus obtains the target information of the to-be-transmitted target data, where the target information is information related to transmission of the target data; and determines the target transmission resource of the target data based on the target information, where the target transmission resource includes the target start resource block RB. The terminal can obtain the target information related to the to-be-transmitted target data, so that the terminal can determine, based on the target information, the target transmission resource used to transmit the target data, that is, can determine the target start resource block RB.

In a possible implementation, the target information includes at least one of the following:
first information, used to indicate a length of a reference frequency domain resource for transmission of the target data, a start RB of the reference frequency domain resource, or an end RB of the reference frequency domain resource;
second information, used to indicate a length of an actual frequency domain resource for transmission of the target data, a start RB of the actual frequency domain resource, or an end RB of the actual frequency domain resource;
third information, used to indicate a type of a time unit for transmission of the target data;
fourth information, used to indicate a data type of the target data;
fifth information, used to indicate a transmission type of the target data;
sixth information, used to indicate an allocation type of a frequency domain resource for transmission of the target data; and
seventh information, used to indicate a frequency domain offset of transmission of the target data.

In a possible implementation, the target start RB includes a reference start RB, the target information includes the first information and the sixth information, and the determining module 42, for example, is configured to determine the reference start RB based on the first information and the sixth information.

In a possible implementation, the determining module 42 is configured to determine the reference start RB based on the length of the reference frequency domain resource and a target allocation manner, where the target allocation manner is an allocation manner corresponding to the allocation type indicated by the sixth information.

In a possible implementation, the target start RB includes an actual start RB, the target information includes the first information, the second information, and the seventh information, and the determining module 42 is configured to determine the actual start RB based on the first information, the second information, and the seventh information.

In a possible implementation, the determining module 42 is configured to: in a case that the length of the reference frequency domain resource for transmission of the target data is greater than or equal to the length of the actual frequency domain resource for transmission of the target data and the reference start RB is greater than or equal to the end RB of the actual frequency domain resource for the transmission of the target data, determine the start RB based on a difference between the reference start RB and the frequency domain offset of transmission of the target data, or determine the start RB based on the start RB of the actual frequency domain resource for the transmission of the target data and the first information, where the first information is a value obtained by performing a modulo operation on the reference start RB and the length of the reference frequency domain resource for transmission of the target data.

For example, the determining module 42 is configured to: in a case that the length of the reference frequency domain resource for transmission of the target data is greater than or equal to the length of the actual frequency domain resource for transmission of the target data and the reference start RB is less than or equal to the end RB of the actual frequency domain resource for the transmission of the target data, determine the start RB based on a value of a sum of the reference start RB and the frequency domain offset of transmission of the target data, or determine the start RB based on the start RB of the actual frequency domain resource for the transmission of the target data and the first information.

For example, the determining module 42 is configured to: in a case that the length of the reference frequency domain resource for transmission of the target data is greater than or equal to the length of the actual frequency domain resource for transmission of the target data and the reference start RB is less than or equal to the end RB of the actual frequency domain resource for the transmission of the target data and is greater than or equal to the start RB of the actual frequency domain resource for the transmission of the target data, determine the start RB based on the reference start RB, or determine the start RB based on the start RB of the actual frequency domain resource for the transmission of the target data and the first information.

In a possible implementation, for example, the determining module 42 is configured to: in a case that the length of the reference frequency domain resource for transmission of the target data is less than or equal to the length of the actual frequency domain resource for transmission of the target data, determine the start RB based on a difference between the reference start RB and the frequency domain offset of transmission of the target data, or determine the start RB based on a value of a sum of the reference start RB and the frequency domain offset of transmission of the target data, or determine the start RB based on the start RB of the actual frequency domain resource for the transmission of the target data and the first information.

In a possible implementation, the apparatus further includes a processing module. The processing module is configured to skip expecting a first condition to be met, or the processing module is configured to abandon transmission of the target data in a case that a first condition is met.

The first condition is: the reference start RB is greater than or equal to the end RB of the actual frequency domain resource for the transmission of the target data, and the reference start RB is less than or equal to the end RB of the actual frequency domain resource for the transmission of the target data;

or

the reference start RB is greater than or equal to the start RB of the actual frequency domain resource for the transmission of the target data, and the reference start RB is less than or equal to the start RB of the actual frequency domain resource for the transmission of the target data.

In a possible implementation, the first information is determined by at least one of the following:
first bandwidth part information, used to indicate a length of a current active uplink bandwidth part, a start RB of the active uplink bandwidth part, or an end RB of the active uplink bandwidth part;
second bandwidth part information, used to indicate a length of a current active downlink bandwidth part, a start RB of the active downlink bandwidth part, or an end RB of the active downlink bandwidth part;
third bandwidth part information, used to indicate a length of an initial uplink bandwidth part, a start RB of the initial uplink bandwidth part, or an end RB of the initial uplink bandwidth part;
fourth bandwidth part information, used to indicate a length of an initial downlink bandwidth part, a start RB of the initial downlink bandwidth part, or an end RB of the initial downlink bandwidth part;
information about a control resource set, used to indicate a frequency domain length of the control resource set, a frequency domain starts RB of the control resource set, or a frequency domain end RB of the control resource set;
first sub-band information, used to indicate a length of an uplink sub-band in a flexible duplex standard, a start RB of the uplink sub-band in the flexible duplex standard, or an end RB of the uplink sub-band in the flexible duplex standard; and
second sub-band information, used to indicate a length of a downlink sub-band in the flexible duplex standard, a start RB of the downlink sub-band in the flexible duplex standard, or an end RB of the downlink sub-band in the flexible duplex standard; or
the first information is configured or indicated by a network side device.

In a possible implementation, the control resource set is a control resource set configured by a serving cell of the terminal for the terminal, or is a control resource set with an index of 0 of the terminal.

In a possible implementation, the second information is determined by at least one of the following:
first frequency domain resource information, used to indicate a length of an available frequency domain of the target data, a start RB of the available frequency domain resource, or an end RB of the available frequency domain resource;
third sub-band information, used to indicate a length of an uplink sub-band, a start RB of the uplink sub-band, or an end RB of the uplink sub-band;
fourth sub-band information, used to indicate a length of a downlink sub-band, a start RB of the downlink sub-band, or an end RB of the downlink sub-band; and
second frequency domain resource information, used to indicate a length of a current active BWP minus a length of a frequency domain resource corresponding to an unavailable frequency domain resource of the target data, a start RB of the active BWP, or an end RB of the active BWP, where a RB of a frequency domain resource corresponding to a start RB of the unavailable frequency domain resource of the target data is an end RB of an actual frequency resource, or a RB of a frequency domain resource corresponding to an end RB of the unavailable frequency domain resource of the target data is a start RB of the actual frequency resource.

In a possible implementation, the available frequency domain resource is a frequency domain resource whose transmission direction is the same as a transmission direction of the target data, and the unavailable frequency domain resource is a frequency domain resource whose transmission direction is different from the transmission direction of the target data;

or

the available frequency domain resource is a frequency domain resource whose transmission direction is not opposite to a transmission direction of the target data, and the unavailable frequency domain resource is a frequency domain resource whose transmission direction is opposite to the transmission direction of the target data.

In a possible implementation, the third information includes at least one of the following:
first time unit information, used to indicate a time unit with no conflict in an uplink direction of the target data;
second time unit information, used to indicate a time unit with no conflict in a downlink direction of the target data;
third time unit information, used to indicate a time unit on an uplink;
fourth time unit information, used to indicate a time unit on a downlink;
fifth time unit information, used to indicate a time unit on an uplink sub-band;
sixth time unit information, used to indicate a time unit on a downlink sub-band;
seventh time unit information, used to indicate a time unit in which no sub-band full-duplex SBFD exists; and
eighth time unit information, used to indicate a time unit in which SBFD exists.

In a possible implementation, the time unit includes at least one slot or at least one orthogonal frequency division multiplexing OFDM symbol.

In a possible implementation, the fourth information is determined by at least one of the following:
being determined by using downlink control information DCI in common search space;
being determined by using DCI in dedicated search space; and
being configured by a network side device.

In a possible implementation, the fifth information includes at least one of the following:
first-type information, used to indicate a single-slot transmission type; and
second-type information, used to indicate a multi-slot transmission type.

In a possible implementation, when the fifth information includes the first-type information, the length of the reference frequency domain resource for transmission of the target data is a length of the reference frequency domain resource that is determined based on the first-type information, the start RB of the reference frequency domain resource is a start RB of the reference frequency domain resource that is determined based on the first-type information, and the end RB of the reference frequency domain resource is an end RB of the reference frequency domain resource that is determined based on the first-type information.

In a possible implementation, when the fifth information includes the second-type information, the length of the reference frequency domain resource for transmission of the target data is a length of the reference frequency domain resource that is determined by the terminal based on target slot information, the start RB of the reference frequency domain resource is a start RB of the reference frequency domain resource that is determined by the terminal based on the target slot information, and the end RB of the reference frequency domain resource is an end RB of the reference frequency domain resource that is determined by the terminal based on the target slot information.

The target slot information is a slot in which first nominal transmission of the multi-slot transmission type indicated by the second-type information is located, or is a slot in which first actual transmission of the multi-slot transmission type is located.

In a possible implementation, the seventh information is configured and/or indicated by a network side device.

In a possible implementation, the determining module 42 is further configured to: in a case that frequency hopping transmission is enabled by transmission of the target data, determine start location information of each frequency hopping transmission.

The determining apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not specifically limited in this embodiment of this application.

The determining apparatus provided in this embodiment of this application can implement the processes in the method embodiments in FIG. 1 to FIG. 13, and a same technical effect can be achieved. To avoid repetition, details are not described herein again.

For example, as shown in FIG. 14, an embodiment of this application further provides a communication device 800, including a processor 801 and a memory 802, and the memory 802 stores a program or an instruction that can be run on the processor 801. For example, in a case that the communication device 800 is a terminal, when the program or the instruction is executed by the processor 801, the steps of the foregoing embodiment of the determining method are implemented, and a same technical effect can be achieved. In a case that the communication device 800 is a network side device, when the program or the instruction is executed by the processor 801, the steps of the foregoing embodiment of the determining method are implemented, and a same technical effect can be achieved. To avoid repetition, details are not described herein again.

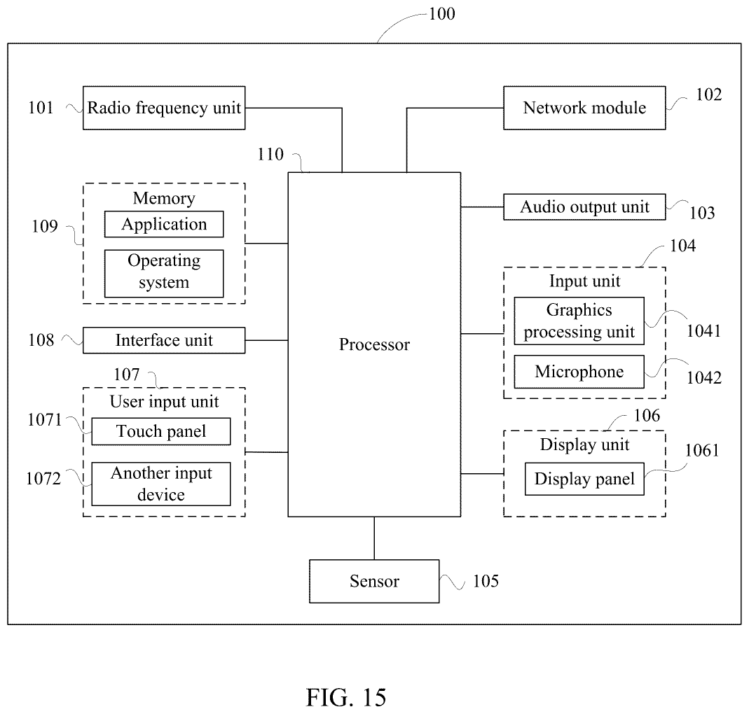

An embodiment of this application further provides a terminal, including a processor and a communication interface. The processor is configured to: obtain target information of to-be-transmitted target data, where the target information is information related to transmission of the target data; and determine a target transmission resource of the target data based on the target information, where the target transmission resource includes a target start resource block RB. The terminal embodiment is corresponding to the method embodiment on the terminal side, each implementation process and implementation of the method embodiment can be applied to the terminal embodiment, and a same technical effect can be achieved. For example, FIG. 15 is a schematic diagram of a hardware structure of a terminal according to an embodiment of this application.

The terminal 100 includes but is not limited to at least some components in a radio frequency unit 101, a network module 102, an audio output unit 103, an input unit 104, a sensor 105, a display unit 106, a user input unit 107, an interface unit 108, a memory 109, a processor 110, and the like.

A person skilled in the art can understand that the terminal 100 may further include a power supply (such as a battery) that supplies power to each component. The power supply may be logically connected to the processor 110 by using a power supply management system, to implement functions such as charging and discharging management, and power consumption management by using the power supply management system. The terminal structure shown in FIG. 15 constitutes no limitation on the terminal, and the terminal may include more or fewer components than those shown in the figure, or combine some components, or have different component arrangements. Details are not described herein.

It should be understood that, in this embodiment of this application, the input unit 104 may include a Graphics Processing Unit (GPU) 1041 and a microphone 1042, and the graphics processing unit 1041 processes image data of a still picture or a video obtained by an image capture apparatus (for example, a camera) in a video capture mode or an image capture mode. The display unit 106 may include a display panel 1061, and the display panel 1061 may be configured in a form of a liquid crystal display, an organic light-emitting diode, or the like. The user input unit 107 includes at least one of a touch panel 1071 and another input device 1072. The touch panel 1071 is also referred to as a touchscreen. The touch panel 1071 may include two parts: a touch detection apparatus and a touch controller. The another input device 1072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 101 may transmit the downlink data to the processor 110 for processing. In addition, the radio frequency unit 101 may send uplink data to the network side device. Generally, the radio frequency unit 101 includes but is not limited to an antenna, an amplifier, a transceiver, a coupler, a low noise amplifier, a duplexer, and the like.

The memory 109 may be configured to store a software program or an instruction and various data. The memory 109 may mainly include a first storage area for storing a program or an instruction and a second storage area for storing data. The first storage area may store an operating system, and an application or an instruction required by at least one function (for example, a sound playing function or an image playing function). In addition, the memory 109 may be a volatile memory or a non-volatile memory, or the memory 109 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 109 in this embodiment of this application includes but is not limited to these memories and any memory of another proper type.

The processor 110 may include one or more processing units. For example, an application processor and a modem processor are integrated into the processor 110. The application processor mainly processes an operating system, a user interface, an application, or the like. The modem processor mainly processes a wireless communication signal, for example, a baseband processor. It may be understood that, in some embodiments, the modem processor may not be integrated into the processor 110.

The processor 110 is configured to obtain target information of to-be-transmitted target data, where the target information is information related to transmission of the target data. The processor 110 is configured to determine a target transmission resource of the target data based on the target information, where the target transmission resource includes a target start resource block RB.

An embodiment of this application provides an electronic device. A terminal obtains the target information of to-be-transmitted target data, where the target information is information related to transmission of the target data; and determines the target transmission resource of the target data based on the target information, where the target transmission resource includes the target start resource block RB. The terminal can obtain the target information related to the to-be-transmitted target data, so that the terminal can determine, based on the target information, the target transmission resource used to transmit the target data, that is, can determine the target start resource block RB.

For example, in this embodiment of this application, the target information includes at least one of the following:
first information, used to indicate a length of a reference frequency domain resource for transmission of the target data, a start RB of the reference frequency domain resource, or an end RB of the reference frequency domain resource;
second information, used to indicate a length of an actual frequency domain resource for transmission of the target data, a start RB of the actual frequency domain resource, or an end RB of the actual frequency domain resource;
third information, used to indicate a type of a time unit for transmission of the target data;
fourth information, used to indicate a data type of the target data;
fifth information, used to indicate a transmission type of the target data;
sixth information, used to indicate an allocation type of a frequency domain resource for transmission of the target data; and
seventh information, used to indicate a frequency domain offset of transmission of the target data.

For example, in this embodiment of this application, the target start RB includes a reference start RB, the target information includes the first information and the sixth information, and the processor 110 is configured to determine the reference start RB based on the first information and the sixth information.

For example, in this embodiment of this application, the processor 110 is configured to determine the reference start RB based on the length of the reference frequency domain resource and a target allocation manner, where the target allocation manner is an allocation manner corresponding to the allocation type indicated by the sixth information.

For example, in this embodiment of this application, the target start RB includes an actual start RB, the target information includes the first information, the second information, and the seventh information, and the processor 110 is configured to determine the actual start RB based on the first information, the second information, and the seventh information.

For example, in this embodiment of this application, the processor 110 is configured to: in a case that the length of the reference frequency domain resource for transmission of the target data is greater than or equal to the length of the actual frequency domain resource for transmission of the target data and the reference start RB is greater than or equal to the end RB of the actual frequency domain resource for the transmission of the target data, determine the start RB based on a difference between the reference start RB and the frequency domain offset of transmission of the target data, or determine the start RB based on the start RB of the actual frequency domain resource for the transmission of the target data and the first information, where the first information is a value obtained by performing a modulo operation on the reference start RB and the length of the reference frequency domain resource for transmission of the target data.

For example, the processor 110 is configured to: in a case that the length of the reference frequency domain resource for transmission of the target data is greater than or equal to the length of the actual frequency domain resource for transmission of the target data and the reference start RB is less than or equal to the end RB of the actual frequency domain resource for the transmission of the target data, determine the start RB based on a value of a sum of the reference start RB and the frequency domain offset of transmission of the target data, or determine the start RB based on the start RB of the actual frequency domain resource for the transmission of the target data and the first information.

For example, the processor 110 is configured to: in a case that the length of the reference frequency domain resource for transmission of the target data is greater than or equal to the length of the actual frequency domain resource for transmission of the target data and the reference start RB is less than or equal to the end RB of the actual frequency domain resource for the transmission of the target data and is greater than or equal to the start RB of the actual frequency domain resource for the transmission of the target data, determine the start RB based on the reference start RB, or determine the start RB based on the start RB of the actual frequency domain resource for the transmission of the target data and the first information.

For example, in this embodiment of this application, the processor 110 is configured to: in a case that the length of the reference frequency domain resource for transmission of the target data is less than or equal to the length of the actual frequency domain resource for transmission of the target data, determine the start RB based on a difference between the reference start RB and the frequency domain offset of transmission of the target data, or determine the start RB based on a value of a sum of the reference start RB and the frequency domain offset of transmission of the target data, or determine the start RB based on the start RB of the actual frequency domain resource for the transmission of the target data and the first information.

For example, in this embodiment of this application, the apparatus further includes a processing module. The processing module is configured to skip expecting a first condition to be met, or the processing module is configured to abandon transmission of the target data in a case that a first condition is met.

The first condition is: the reference start RB is greater than or equal to the end RB of the actual frequency domain resource for the transmission of the target data, and the reference start RB is less than or equal to the end RB of the actual frequency domain resource for the transmission of the target data;

or

the reference start RB is greater than or equal to the start RB of the actual frequency domain resource for the transmission of the target data, and the reference start RB is less than or equal to the start RB of the actual frequency domain resource for the transmission of the target data.

For example, in this embodiment of this application, the first information is determined by at least one of the following:
first bandwidth part information, used to indicate a length of a current active uplink bandwidth part, a start RB of the active uplink bandwidth part, or an end RB of the active uplink bandwidth part;
second bandwidth part information, used to indicate a length of a current active downlink bandwidth part, a start RB of the active downlink bandwidth part, or an end RB of the active downlink bandwidth part;
third bandwidth part information, used to indicate a length of an initial uplink bandwidth part, a start RB of the initial uplink bandwidth part, or an end RB of the initial uplink bandwidth part;
fourth bandwidth part information, used to indicate a length of an initial downlink bandwidth part, a start RB of the initial downlink bandwidth part, or an end RB of the initial downlink bandwidth part;
information about a control resource set, used to indicate a frequency domain length of the control resource set, a frequency domain starts RB of the control resource set, or a frequency domain end RB of the control resource set;
first sub-band information, used to indicate a length of an uplink sub-band in a flexible duplex standard, a start RB of the uplink sub-band in the flexible duplex standard, or an end RB of the uplink sub-band in the flexible duplex standard; and
second sub-band information, used to indicate a length of a downlink sub-band in the flexible duplex standard, a start RB of the downlink sub-band in the flexible duplex standard, or an end RB of the downlink sub-band in the flexible duplex standard; or
the first information is configured or indicated by a network side device.

For example, in this embodiment of this application, the control resource set is a control resource set configured by a serving cell of the terminal for the terminal, or is a control resource set with an index of 0 of the terminal.

For example, in this embodiment of this application, the second information is determined by at least one of the following:
first frequency domain resource information, used to indicate a length of an available frequency domain of the target data, a start RB of the available frequency domain resource, or an end RB of the available frequency domain resource;
third sub-band information, used to indicate a length of an uplink sub-band, a start RB of the uplink sub-band, or an end RB of the uplink sub-band;
fourth sub-band information, used to indicate a length of a downlink sub-band, a start RB of the downlink sub-band, or an end RB of the downlink sub-band; and
second frequency domain resource information, used to indicate a length of a current active BWP minus a length of a frequency domain resource corresponding to an unavailable frequency domain resource of the target data, a start RB of the active BWP, or an end RB of the active BWP, where a RB of a frequency domain resource corresponding to a start RB of the unavailable frequency domain resource of the target data is an end RB of an actual frequency resource, or a RB of a frequency domain resource corresponding to an end RB of the unavailable frequency domain resource of the target data is a start RB of the actual frequency resource.

For example, in this embodiment of this application, the available frequency domain resource is a frequency domain resource whose transmission direction is the same as a transmission direction of the target data, and the unavailable frequency domain resource is a frequency domain resource whose transmission direction is different from the transmission direction of the target data;

or

the available frequency domain resource is a frequency domain resource whose transmission direction is not opposite to a transmission direction of the target data, and the unavailable frequency domain resource is a frequency domain resource whose transmission direction is opposite to the transmission direction of the target data.

For example, in this embodiment of this application, the third information includes at least one of the following:
first time unit information, used to indicate a time unit with no conflict in an uplink direction of the target data;
second time unit information, used to indicate a time unit with no conflict in a downlink direction of the target data;
third time unit information, used to indicate a time unit on an uplink;
fourth time unit information, used to indicate a time unit on a downlink;
fifth time unit information, used to indicate a time unit on an uplink sub-band;
sixth time unit information, used to indicate a time unit on a downlink sub-band;
seventh time unit information, used to indicate a time unit in which no sub-band full-duplex SBFD exists; and
eighth time unit information, used to indicate a time unit in which SBFD exists.

For example, in this embodiment of this application, the time unit includes at least one slot or at least one orthogonal frequency division multiplexing OFDM symbol.

For example, in this embodiment of this application, the fourth information is determined by at least one of the following:
being determined by using downlink control information DCI in common search space;
being determined by using DCI in dedicated search space; and
being configured by a network side device.

For example, in this embodiment of this application, the fifth information includes at least one of the following:
first-type information, used to indicate a single-slot transmission type; and
second-type information, used to indicate a multi-slot transmission type.

For example, in this embodiment of this application, when the fifth information includes the first-type information, the length of the reference frequency domain resource for transmission of the target data is a length of the reference frequency domain resource that is determined based on the first-type information, the start RB of the reference frequency domain resource is a start RB of the reference frequency domain resource that is determined based on the first-type information, and the end RB of the reference frequency domain resource is an end RB of the reference frequency domain resource that is determined based on the first-type information.

For example, in this embodiment of this application, when the fifth information includes the second-type information, the length of the reference frequency domain resource for transmission of the target data is a length of the reference frequency domain resource that is determined by the terminal based on target slot information, the start RB of the reference frequency domain resource is a start RB of the reference frequency domain resource that is determined by the terminal based on the target slot information, and the end RB of the reference frequency domain resource is an end RB of the reference frequency domain resource that is determined by the terminal based on the target slot information.

The target slot information is a slot in which first nominal transmission of the multi-slot transmission type indicated by the second-type information is located, or is a slot in which first actual transmission of the multi-slot transmission type is located.

For example, in this embodiment of this application, the seventh information is configured and/or indicated by the network side device.

For example, in this embodiment of this application, the processor 110 is further configured to: in a case that frequency hopping transmission is enabled by transmission of the target data, determine start location information of each frequency hopping transmission.

An embodiment of this application further provides a readable storage medium. The readable storage medium stores a program or an instruction, and when the program or the instruction is executed by a processor, the processes of the foregoing embodiment of the determining method are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip, the chip includes a processor and a communication interface, the communication interface is coupled to the processor, and the processor is configured to run a program or an instruction to implement the processes of the foregoing embodiment of the determining method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a non-volatile storage medium, and the computer program/program product is executed by at least one processor to implement the processes of the foregoing embodiment of the determining method, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is an example implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A determining method, comprising:
obtaining, by a terminal, target information of to-be-transmitted target data, wherein the target information is information related to transmission of the target data; and
determining, by the terminal, a target transmission resource of the target data based on the target information, wherein the target transmission resource comprises a target start Resource Block (RB).

2. The determining method according to claim 1, wherein the target information comprises at least one of the following:
first information, used to indicate a length of a reference frequency domain resource for transmission of the target data, a start RB of the reference frequency domain resource, or an end RB of the reference frequency domain resource;
second information, used to indicate a length of an actual frequency domain resource for transmission of the target data, a start RB of the actual frequency domain resource, or an end RB of the actual frequency domain resource;
third information, used to indicate a type of a time unit for transmission of the target data;
fourth information, used to indicate a data type of the target data;
fifth information, used to indicate a transmission type of the target data;
sixth information, used to indicate an allocation type of a frequency domain resource for transmission of the target data; or
seventh information, used to indicate a frequency domain offset of transmission of the target data.

3. The determining method according to claim 2, wherein the target start RB comprises a reference start RB, and the target information comprises the first information and the sixth information, and
the determining, by the terminal, the target transmission resource of the target data based on the target information comprises:
determining, by the terminal, the reference start RB based on the first information and the sixth information.

4. The determining method according to claim 3, wherein the determining, by the terminal, the reference start RB based on the first information and the sixth information comprises:
determining, by the terminal, the reference start RB based on the length of the reference frequency domain resource and a target allocation manner, wherein the target allocation manner is an allocation manner corresponding to the allocation type indicated by the sixth information.

5. The determining method according to claim 3, wherein the target start RB comprises an actual start RB, and the target information comprises the first information, the second information, and the seventh information, and
the determining, by the terminal, the target transmission resource of the target data based on the target information comprises:
determining, by the terminal, the actual start RB based on the first information, the second information, and the seventh information.

6. The determining method according to claim 5, wherein the determining, by the terminal, the actual start RB based on the first information, the second information, and the seventh information comprises:
when the length of the reference frequency domain resource for transmission of the target data is greater than or equal to the length of the actual frequency domain resource for transmission of the target data and the reference start RB is greater than or equal to the end RB of the actual frequency domain resource for the transmission of the target data, determining, by the terminal, the actual start RB based on a difference between the reference start RB and the frequency domain offset of transmission of the target data, or determining the actual start RB based on the start RB of the actual frequency domain resource for the transmission of the target data and the first information, wherein the first information is a value obtained by performing a modulo operation on the reference start RB and the length of the reference frequency domain resource for transmission of the target data;
when the length of the reference frequency domain resource for transmission of the target data is greater than or equal to the length of the actual frequency domain resource for transmission of the target data and the reference start RB is less than or equal to the end RB of the actual frequency domain resource for the transmission of the target data, determining, by the terminal, the actual start RB based on a value of a sum of the reference start RB and the frequency domain offset of transmission of the target data, or determining the actual start RB based on the start RB of the actual frequency domain resource for the transmission of the target data and the first information; and
when the length of the reference frequency domain resource for transmission of the target data is greater than or equal to the length of the actual frequency domain resource for transmission of the target data and the reference start RB is less than or equal to the end RB of the actual frequency domain resource for the transmission of the target data and is greater than or equal to the start RB of the actual frequency domain resource for the transmission of the target data, determining, by the terminal, the actual start RB based on the reference start RB, or determining the actual start RB based on the start RB of the actual frequency domain resource for the transmission of the target data and the first information.

7. The determining method according to claim 6, further comprising:
when the length of the reference frequency domain resource for transmission of the target data is less than or equal to the length of the actual frequency domain resource for transmission of the target data, determining, by the terminal, the actual start RB based on a difference between the reference start RB and the frequency domain offset of transmission of the target data, or determining, by the terminal, the actual start RB based on a value of a sum of the reference start RB and the frequency domain offset of transmission of the target data, or determining the actual start RB based on the start RB of the actual frequency domain resource for the transmission of the target data and the first information.

8. The determining method according to claim 6, further comprising:
skipping, by the terminal, expecting a first condition to be met, or abandoning, by the terminal, transmission of the target data when a first condition is met, wherein
the first condition is:
the reference start RB is greater than or equal to the end RB of the actual frequency domain resource for the transmission of the target data, and the reference start RB is less than or equal to the end RB of the actual frequency domain resource for the transmission of the target data; or
the reference start RB is greater than or equal to the start RB of the actual frequency domain resource for the transmission of the target data, and the reference start RB is less than or equal to the start RB of the actual frequency domain resource for the transmission of the target data.

9. The determining method according to claim 2, wherein the first information is determined by at least one of the following:
first bandwidth part information, used to indicate a length of a current active uplink bandwidth part, a start RB of the active uplink bandwidth part, or an end RB of the active uplink bandwidth part;
second bandwidth part information, used to indicate a length of a current active downlink bandwidth part, a start RB of the active downlink bandwidth part, or an end RB of the active downlink bandwidth part;
third bandwidth part information, used to indicate a length of an initial uplink bandwidth part, a start RB of the initial uplink bandwidth part, or an end RB of the initial uplink bandwidth part;
fourth bandwidth part information, used to indicate a length of an initial downlink bandwidth part, a start RB of the initial downlink bandwidth part, or an end RB of the initial downlink bandwidth part;
information about a control resource set, used to indicate a frequency domain length of the control resource set, a frequency domain starts RB of the control resource set, or a frequency domain end RB of the control resource set;
first sub-band information, used to indicate a length of an uplink sub-band in a flexible duplex standard, a start RB of the uplink sub-band in the flexible duplex standard, or an end RB of the uplink sub-band in the flexible duplex standard;
second sub-band information, used to indicate a length of a downlink sub-band in the flexible duplex standard, a start RB of the downlink sub-band in the flexible duplex standard, or an end RB of the downlink sub-band in the flexible duplex standard; or
configured or indicated by a network side device.

10. The method according to claim 9, wherein
the control resource set is a control resource set configured by a serving cell of the terminal for the terminal, or is a control resource set with an index of 0 of the terminal.

11. The determining method according to claim 2, wherein the second information is determined by at least one of the following:
first frequency domain resource information, used to indicate a length of an available frequency domain resource of the target data, a start RB of the available frequency domain resource, or an end RB of the available frequency domain resource;
third sub-band information, used to indicate a length of an uplink sub-band, a start RB of the uplink sub-band, or an end RB of the uplink sub-band;
fourth sub-band information, used to indicate a length of a downlink sub-band, a start RB of the downlink sub-band, or an end RB of the downlink sub-band; or
second frequency domain resource information, used to indicate a length of a current active BandWidth Part (BWP) minus a length of a frequency domain resource corresponding to an unavailable frequency domain resource of the target data, a start RB of the active BWP, or an end RB of the active BWP, wherein a RB of a frequency domain resource corresponding to a start RB of the unavailable frequency domain resource of the target data is an end RB of an actual frequency resource, or a RB of a frequency domain resource corresponding to an end RB of the unavailable frequency domain resource of the target data is a start RB of the actual frequency resource.

12. The determining method according to claim 2, wherein the third information comprises at least one of the following:
first time unit information, used to indicate a time unit with no conflict in an uplink direction of the target data;
second time unit information, used to indicate a time unit with no conflict in a downlink direction of the target data;
third time unit information, used to indicate a time unit on an uplink;
fourth time unit information, used to indicate a time unit on a downlink;
fifth time unit information, used to indicate a time unit on an uplink sub-band;
sixth time unit information, used to indicate a time unit on a downlink sub-band;
seventh time unit information, used to indicate a time unit in which no sub-band full-duplex SBFD exists; or
eighth time unit information, used to indicate a time unit in which SBFD exists.

13. The determining method according to claim 2, wherein the fourth information is determined by at least one of the following:
being determined by using Downlink Control Information (DCI) in common search space;
being determined by using DCI in dedicated search space; or being configured by a network side device,
or
wherein the fifth information comprises at least one of the following:
first-type information, used to indicate a single-slot transmission type; or
second-type information, used to indicate a multi-slot transmission type.

14. The determining method according to claim 13, wherein
when the fifth information comprises the first-type information, the length of the reference frequency domain resource for transmission of the target data is a length of the reference frequency domain resource that is determined based on the first-type information, the start RB of the reference frequency domain resource is a start RB of the reference frequency domain resource that is determined based on the first-type information, and the end RB of the reference frequency domain resource is an end RB of the reference frequency domain resource that is determined based on the first-type information; or
when the fifth information comprises the second-type information, the length of the reference frequency domain resource for transmission of the target data is a length of the reference frequency domain resource that is determined by the terminal based on target slot information, the start RB of the reference frequency domain resource is a start RB of the reference frequency domain resource that is determined by the terminal based on the target slot information, and the end RB of the reference frequency domain resource is an end RB of the reference frequency domain resource that is determined by the terminal based on the target slot information, wherein
the target slot information is a slot in which first nominal transmission of the multi-slot transmission type indicated by the second-type information is located, or is a slot in which first actual transmission of the multi-slot transmission type is located.

15. The determining method according to claim 1, further comprising:
when frequency hopping transmission is enabled by transmission of the target data, determining, by the terminal, start location information of each frequency hopping transmission.

16. A terminal, comprising a processor and a memory storing instructions, wherein the instructions, when executed by the processor, cause the processor to perform operations comprising:
obtaining target information of to-be-transmitted target data, wherein the target information is information related to transmission of the target data; and
determining a target transmission resource of the target data based on the target information, wherein the target transmission resource comprises a target start Resource Block (RB).

17. The terminal according to claim 16, wherein the target information comprises at least one of the following:
first information, used to indicate a length of a reference frequency domain resource for transmission of the target data, a start RB of the reference frequency domain resource, or an end RB of the reference frequency domain resource;
second information, used to indicate a length of an actual frequency domain resource for transmission of the target data, a start RB of the actual frequency domain resource, or an end RB of the actual frequency domain resource;
third information, used to indicate a type of a time unit for transmission of the target data;
fourth information, used to indicate a data type of the target data;
fifth information, used to indicate a transmission type of the target data;
sixth information, used to indicate an allocation type of a frequency domain resource for transmission of the target data; or
seventh information, used to indicate a frequency domain offset of transmission of the target data.

18. The terminal according to claim 17, wherein the target start RB comprises a reference start RB, and the target information comprises the first information and the sixth information, and
the determining the target transmission resource of the target data based on the target information comprises:
determining the reference start RB based on the first information and the sixth information.

19. The terminal according to claim 18, wherein the determining the reference start RB based on the first information and the sixth information comprises:
determining the reference start RB based on the length of the reference frequency domain resource and a target allocation manner, wherein the target allocation manner is an allocation manner corresponding to the allocation type indicated by the sixth information.

20. The terminal according to claim 18, wherein the target start RB comprises an actual start RB, and the target information comprises the first information, the second information, and the seventh information, and
the determining the target transmission resource of the target data based on the target information comprises:
determining the actual start RB based on the first information, the second information, and the seventh information.
